(19) United States
(12) Patent Application Publication
(10) Pub. No.: US 2015/0103464 A1
(43) Pub. Date: Apr. 16, 2015

(54) STATIC-PROTECTIVE COMPONENT AND STATIC-PROTECTIVE COMPOSITION

(71) Applicant: SAMSUNG ELECTRO-MECHANICS CO., LTD., Suwon (KR)

(72) Inventors: Bon Seok KOO, Suwon (KR); Byung Ho JUN, Suwon (KR); Jung Wook SEO, Suwon (KR)

(73) Assignee: SAMSUNG ELECTRO-MECHANICS CO., LTD., Suwon (KR)

(21) Appl. No.: 14/150,295

(22) Filed: Jan. 8, 2014

(30) Foreign Application Priority Data
Oct. 16, 2013 (KR) 10-2013-0123429

(51) Int. Cl. H05F 3/04; H01B 1/22

(52) U.S. Cl. CPC H05F 3/04; H01B 1/22
USPC 361/220; 252/512

(57) ABSTRACT

There is provided a static-protective component including: an insulating substrate; first and second electrodes disposed on the insulating substrate, having a gap of a predetermined interval therebetween; and a turn-on voltage controlling unit disposed at the gap and containing conductive particles and non-conductive particles each having a particle diameter of 120 nm to 1000 nm.

### CROSS-REFERENCE TO RELATED APPLICATION

This application claims the benefit of Korean Patent Application No. 10-2013-0123429 filed on Oct. 16, 2013, with the Korean Intellectual Property Office, the disclosure of which is incorporated herein by reference.

### BACKGROUND

The present disclosure relates to a static-protective component and a static-protective composition.

Recently, electronic devices such as portable information device have rapidly become miniaturized and highly functionalized. Accordingly, electronic components mounted on the electronic devices have also been rapidly miniaturized. However, since a withstand voltage of the electronic device or the electronic component is decreased by the miniaturization, a problem in which electronic circuits (electronic components) in the electronic devices such as the portable information device are destroyed by a static pulse generated when terminals of the electronic devices contact a charged human body or an overvoltage applied by external noise from an antenna of the portable information device has been occurring increasingly frequently.

Therefore, demand for components capable of effectively protecting the electronic component from the static pulse or the external noise is increasing.

### SUMMARY

An aspect of the present disclosure may provide a static-protective component and a static-protective composition capable of easily controlling a turn-on voltage and decreasing a leakage current.

According to an aspect of the present disclosure, a static-protective component may include: an insulating substrate; first and second electrodes disposed on the insulating substrate, having a gap of a predetermined interval therebetween; and a turn-on voltage controlling unit disposed at the gap and containing conductive particles and non-conductive particles each having particle diameter of 120 nm to 1000 nm.

The conductive particle may have a particle diameter of 30 μm or less.

The conductive particle may have at least one of a spherical shape, a flake shape, and a plate shape.

The non-conductive particles may be contained in a content of 5 to 120 parts by weight based on 100 parts by weight of the conductive particle.

The non-conductive particle may contain at least one of a metal oxide and a semiconductor oxide.

The turn-on voltage controlling unit may further include a binder resin.

The binder resin may be contained in a content of 5 to 40 parts by weight based on 100 parts by weight of a solid content containing the conductive particles and the non-conductive particles.

The binder resin may be a thermosetting resin.

According to another aspect of the present disclosure, a static-protective composition may include: conductive particles; non-conductive particles each having a particle diameter of 120 nm to 1000 nm; and a binder resin.

The non-conductive particles may be contained in a content of 5 to 120 parts by weight based on 100 parts by weight of the conductive particle.

The binder resin may be contained in a content of 5 to 40 parts by weight based on 100 parts by weight of a solid content containing the conductive particles and the non-conductive particles.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a cross-sectional view schematically showing a static-protective component according to an exemplary embodiment of the present disclosure;

FIGS. 2A through 2C are views schematically showing a constitution of a static-protective composition according to an exemplary embodiment of the present disclosure; and

FIGS. 3A and 3B are graphs showing electrical properties of the static-protective component manufactured according to an exemplary embodiment of the present disclosure.

### DETAILED DESCRIPTION

Exemplary embodiments of the present disclosure will now be described in detail with reference to the accompanying drawings.

The disclosure may, however, be exemplified in many different forms and should not be construed as being limited to the specific embodiments set forth herein. Rather, these embodiments are provided so that this disclosure will be thorough and complete, and will fully convey the scope of the disclosure to those skilled in the art.

In the drawings, the shapes and dimensions of elements may be exaggerated for clarity, and the same reference numerals will be used throughout to designate the same or like elements.

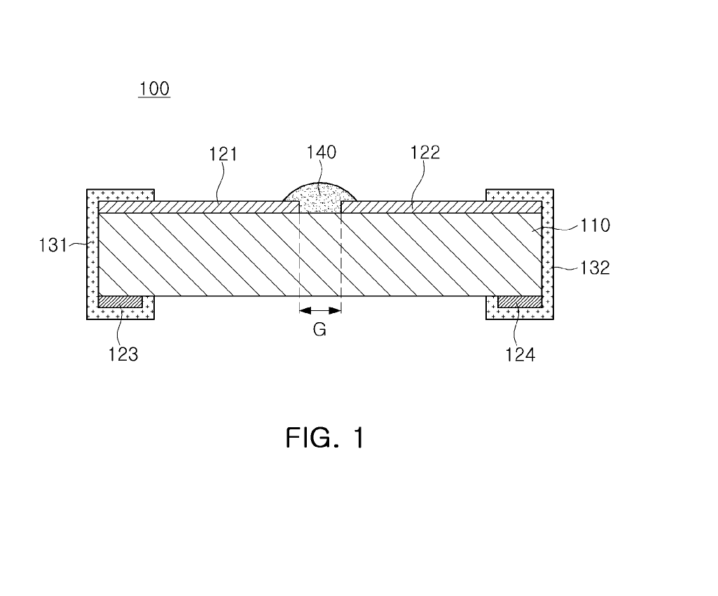

FIG. 1 is a cross-sectional view schematically showing a static-protective component according to an exemplary embodiment of the present disclosure.

Referring to FIG. 1, the exemplary embodiment of the present disclosure may provide a static-protective component 100 including an insulating substrate 110; a first electrode 121 and a second electrode 122; and a turn-on voltage controlling unit 140.

The first and second electrodes may be disposed on the insulating substrate having a predetermined gap G therebetween. That is, the first and second electrodes may be spaced apart from each other by a predetermined interval.

The insulating substrate 110 may have the first electrode 121 and the second electrode 122 formed on one surface thereof and have a third electrode 123 and a fourth electrode 124 formed on the other surface thereof. The first and second electrodes may be formed throughout a length direction of the substrate on the one surface of the substrate, and the third and fourth electrodes may be formed in a region adjacent to both ends in a length direction of the substrate on the other surface of the substrate.

The gap G may be formed by a laser beam, but the present disclosure is not limited thereto. A portion of the electrode formed on the one surface of the insulating substrate may be removed by a laser beam, such that the first and second electrodes, separated while forming the gap, may be formed.

The gap may have an appropriate dimension depending on desired discharge properties, and for example, the appropriate dimension may be 30 μm to 300 μm.

The turn-on voltage controlling unit 140 may be disposed on the gap between the first electrode and the second electrode turn-on voltage controlling unit, wherein the turn-on voltage controlling unit may be connected to the first electrode 121 and the second electrode 122.

In other words, the turn-on voltage controlling unit may be formed between the first and second electrodes having the gap therebetween and opposing each other.

In addition, the turn-on voltage controlling unit 140 may be formed at the gap and partially overlapped with the first electrode 121 and the second electrode 122 as shown in FIG. 1.

In the case in which the gap is partially overlapped with the first electrode and the second electrode, connectivity between the turn-on voltage controlling unit and the first and second electrodes may be improved.

The static-protective component including the turn-on voltage controlling unit may be mounted on a printed circuit board, and be formed between a line to which an overvoltage is applied and a ground in order to protect other electronic circuits (electronic component) mounted on the printed circuit board from the static pulse or the overvoltage due to external noise.

The turn-on voltage controlling unit 140 may contain conductive particles, non-conductive particles, and a binder resin, and may be formed by a static-protective composition containing the conductive particles, the non-conductive particles, and the binder resin.

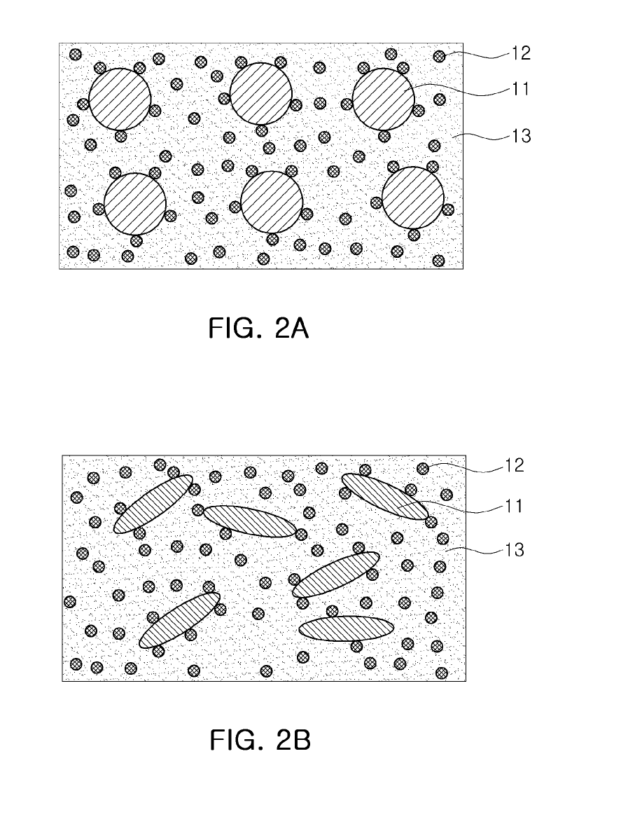

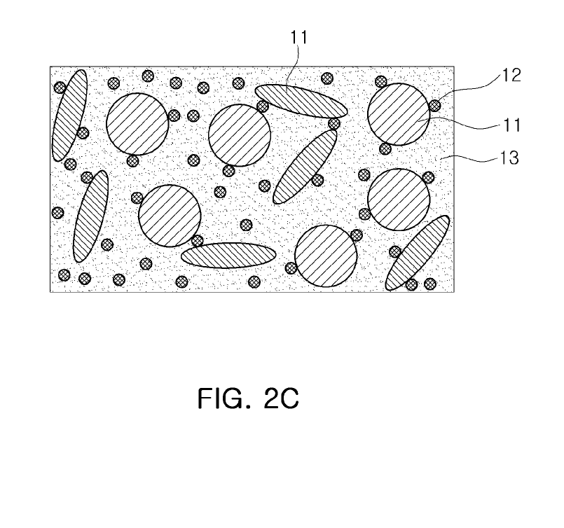

FIGS. 2A through 2C are views schematically showing a static-protective composition according to the exemplary embodiment of the present disclosure.

The static-protective composition according to the exemplary embodiment of the present disclosure may contain conductive particles 11, non-conductive particles 12, and a binder resin 13.

The conductive particle 11 may be a particle in which separate surface treatments, such as forming an oxide layer on a surface thereof or applying an insulating material thereto, are not performed.

The conductive particle may contain at least one of manganese (Mn), zirconium (Zr), tantalum (Ta), molybdenum (Mo), nickel (Ni), cobalt (Co), aluminum (Al), chromium (Cr), and alloys thereof, and two different kinds of metals may be used.

The static-protective composition may contain a plurality of conductive particles, wherein the conductive particle may have at least one of a spherical shape, a flake shape, and a plate shape. That is, the static-protective composition may contain spherical-shaped conductive particles as shown in FIG. 2A, flake-shaped conductive particles as shown in FIG. 2B, and may mixing mix of spherical-shaped conductive particles and flake-shaped conductive particles as shown in FIG. 2C. In addition, although not shown, the static-protective composition may contain conductive particles of all of the spherical shape, the flake shape, and the plate shape.

The conductive particle may have a particle diameter of 30 μm or less. Considering the agglomeration of the particles, the size of the conductive particle may be within 1/10 of the gap between the electrodes. Therefore, in the case in which the maximum size of the gap between the electrodes is 300 μm, the conductive particle may have a diameter of 30 μm or less, which is 1/10 of the size of the gap between the electrodes.

The static-protective composition may contain a plurality of non-conductive particle 12, wherein the non-conductive particles may be oxides of metals or semiconductors.

More specifically, the non-conductive particles may contain at least one of zinc oxide (ZnO) and silica (SiO₂), which are oxides of metals contained in the conductive particles.

The non-conductive particles may be disposed between the conductive particles, thereby electrically insulating the conductive particles in the case in which a normal electric current flows in a circuit.

The non-conductive particle 12 may have a particle diameter of ⅛ or less of that of the conductive particle 11.

That is, the conductive particle may have a particle diameter 8 times larger than that of the non-conductive particle.

In addition, the non-conductive particle 12 may have a particle diameter of 120 nm to 1000 nm. In the case in which the non-conductive particle has a diameter smaller than 120 nm, an interval between the conductive particles may not be secured thereby easily causing a short circuit, such that it is difficult to control a turn-on voltage. In the case in which the non-conductive particle has a diameter greater than 1000 nm, conductivity may be decreased thereby deteriorating a turn-on voltage or a clamp voltage during electricity discharge.

The turn-on voltage may refer to a voltage in which a current starts flowing through the first and second electrodes. In the case in which the turn-on voltage is high, when an amount of an over-current is large, the first and second electrodes may be electrically connected to each other, such that a current in a circuit may flow to a ground electrode, and in the case in which the turn-on voltage is low, the current in the circuit may flow to the ground electrode even with a small amount of the over-current.

In addition, the non-conductive particles 12 may be contained in a content of 5 to 120 parts by weight based on 100 parts by weight of the conductive particle 11. In the case in which the non-conductive particles are contained in a content of less than 5 parts by weight, a leakage current may be generated thereby causing a short-circuit, and in the case in which the non-conductive particles are contained in a content of more than 120 parts by weight, the conductivity may be decreased thereby deteriorating the turn-on voltage or the clamp voltage. In addition, in the case in which the non-conductive particles 12 are contained in a content of more than 120 parts by weight based on 100 parts by weight of the conductive particle 11 in the static-protective composition, printability and workability during screen-printing may deteriorate due to an increase in viscosity of the static-protective composition.

The binder resin 13 may be contained in a content of 5 to 40 parts by weight based on 100 parts by weight of a solid content containing the conductive particles 11 and the non-conductive particles 12.

In the case in which the content of the binder resin is less than 5 parts by weight, combination or dispersion of the conductive particles and the non-conductive particles may not be facilitated, and in the case in which the content of the binder resin is more than 40 parts by weight, a protective function may not operate during generation of static electricity or electrostatic discharge (ESD) due to a lack of the solid content or an increase in a distance between the particles.

The binder resin may be a photocurable resin or a thermosetting resin, and may be, for example, an epoxy resin and a urethane resin, but the present disclosure is not limited thereto.

The static-protective composition may be prepared by weighing each of the conductive particles, the non-conductive particles and the binder resin depending on a predetermined addition ratio and mixing them together. Depending on viscosity of the composition, milling methods such as ball-mill, apex-mill, and 3 roll-mill methods may be appropriately used, but the present disclosure is not limited thereto.

In addition, the static-protective composition may further contain an additional solvent to control the viscosity to be appropriate for a printing process or a dispensing process after mixing the conductive particles, the non-conductive particles, and the binder resin.

The turn-on voltage controlling unit 140 may be formed by applying the static-protective composition to the gap between the first and second electrodes and then curing the binder resin. As described above, in the case in which the binder resin is a thermosetting resin, the binder resin may be formed by performing a curing process at a curing temperature of the binder resin for a predetermined time, and in the case in which the binder resin is a photocurable resin, the binder resin may be formed by applying the static-protective composition thereto and then irradiating light.

A method of applying the static-protective composition may include a screen printing method, a dispensing method, or the like, but the present disclosure is not limited thereto.

In the case in which the static-protective composition obtained by mixing the conductive particles and the non-conductive particles which are not subjected to separate surface treatments as described in the exemplary embodiment of the present disclosure is used to control the turn-on voltage, rather than forming an insulating film on the surface of the conductive particles, the turn-on voltage may be precisely controlled.

More specifically, in the case in which the insulating film is formed on the surface of the conductive particle to form a protective-composition by static electricity, it is difficult to control a thickness of the insulating film, and the thickness of the insulating film formed on the surface of the plurality of conductive particles is not uniform, such that a leakage current in which a current leaks to a ground electrode before reaching the turn-on voltage may occur.

However, according to the exemplary embodiment of the present disclosure, the non-conductive particles already having insulation properties may be disposed among the conductive particles, such that it is easy to control the insulation properties among the conductive particles. In addition, the distance between metal powders may be easily controlled through a change in the addition amount and the diameter of the non-conductive particles, such that the turn-on voltage, a voltage in which an insulated state changes to a state in which the current flows, may be easily controlled.

In particular, in the case in which the conductive particles each having the flake shape are used in order to decrease the turn-on voltage, since the conductive particles each having the flake shape may not be aligned in one direction, there is a high probability that a leakage current may occur at a low voltage due to contact between the conductive particles. However, in the case of adding the non-conductive particles each having a particle diameter of 120 nm to 1000 nm, the distance between the conductive particles each having the flake shape may be uniformly maintained, such that the insulation state may be maintained up to the point at which the insulation state changes to the state in which the current flows.

The turn-on voltage controlling unit formed by the static-protective composition may have the conductive particles and the non-conductive particles each having a particle diameter of 120 nm to 1000 nm.

In addition, the binder resin may be further contained for the combination and dispersion of the conductive particles and the non-conductive particles.

The non-conductive particles may be contained in a content of 5 to 120 parts by weight based on 100 parts by weight of the conductive particle, and the binder resin may be contained in a content of 5 to 40 parts by weight based on 100 parts by weight of the solid content formed of the conductive particles and the non-conductive particles.

Since details related to the conductive particle, the non-conductive particle, and the binder resin contained in the turn-on voltage controlling unit overlap with the foregoing description related to the static-protective composition, the overlapped portions will be omitted.

Both end surfaces of the insulating substrate may be provided with end-surface electrodes. The end-surface electrodes may include a first end-surface electrode connecting the first electrode and the third electrode and a second end-surface electrode connecting the second electrode and the fourth electrode.

In order to improve reliability, the end-surface electrodes may include a plating film (not-shown), and a nickel plating film and a tinplating film may be formed sequentially.

### Experimental Example

The following Table 1 is data showing leakage current and turn-on voltage of the static-protective component and printing properties of the static-protective composition depending on size and content of the non-conductive particle contained in the static-protective composition to form the turn-on voltage controlling unit of the static-protective component.

The turn-on voltage controlling unit may contain the conductive particles having a diameter of 1 μm, and silica (SiO₂) as the non-conductive particles. The epoxy resin used as the binder resin was contained in a content of 25 parts by weight based on 100 parts by weight of the solid content containing the conductive-particles and the non-conductive particles.

Regarding the leakage current, the case in which the leakage current was 1 μA or less was defined as normal (∘) and the case in which the leakage current was more than 1 μA was defined as defective (x); regarding the printing properties, the case in which viscosity was at a point in which patterns are normally formed in a printing process of 150000 Cps or less was defined as normal (∘) and the case in which viscosity was more than 150000 Cps was defined as defective (x).

TABLE 1

| | Particle | Parts by Weight of | | | |
|---|---|---|---|---|---|
| | Diameter | Non-conductive | | | |
| | (nm) of | Particle Based on | | | |
| | Non- | 100 Parts by Weight | | Turn-on | |
| | conductive | of Conductive | Leakage | Voltage | Printing |
| Sample | Particle | Particle | Current | (V) | Properties |
| 1 | 1100 | 130 | ∘ | 2245 | x |
| 2 | 1100 | 120 | ∘ | 1945 | x |
| 3 | 1100 | 115 | ∘ | 1784 | x |
| 4 | 1100 | 98 | ∘ | 1567 | x |
| 5 | 1100 | 10 | ∘ | 985 | x |
| 6 | 1100 | 5 | ∘ | 880 | x |
| 7 | 1100 | 3 | x | — | ∘ |
| 8 | 1000 | 130 | ∘ | 1515 | x |
| 9 | 1000 | 120 | ∘ | 1422 | ∘ |
| 10 | 1000 | 115 | ∘ | 1324 | ∘ |
| 11 | 1000 | 98 | ∘ | 1023 | ∘ |
| 12 | 1000 | 10 | ∘ | 580 | ∘ |
| 13 | 1000 | 5 | ∘ | 524 | ∘ |
| 14 | 1000 | 3 | x | — | ∘ |
| 15 | 820 | 130 | ∘ | 1325 | x |
| 16 | 820 | 120 | ∘ | 1184 | ∘ |
| 17 | 820 | 115 | ∘ | 1024 | ∘ |
| 18 | 820 | 98 | ∘ | 812 | ∘ |
| 19 | 820 | 10 | ∘ | 515 | ∘ |
| 20 | 820 | 5 | ∘ | 465 | ∘ |
| 21 | 820 | 3 | x | — | ∘ |
| 22 | 160 | 130 | ∘ | 722 | x |
| 23 | 160 | 120 | ∘ | 624 | ∘ |
| 24 | 160 | 115 | ∘ | 586 | ∘ |
| 25 | 160 | 98 | ∘ | 512 | ∘ |
| 26 | 160 | 10 | ∘ | 247 | ∘ |
| 27 | 160 | 5 | ∘ | 215 | ∘ |
| 28 | 160 | 3 | x | — | ∘ |
| 29 | 120 | 130 | ∘ | 662 | x |
| 30 | 120 | 120 | ∘ | 597 | ∘ |
| 31 | 120 | 115 | ∘ | 564 | ∘ |
| 32 | 120 | 98 | ∘ | 456 | ∘ |
| 33 | 120 | 10 | ∘ | 322 | ∘ |
| 34 | 120 | 5 | ∘ | 198 | ∘ |
| 35 | 120 | 3 | x | — | ∘ |
| 36 | 75 | 130 | ∘ | 643 | x |
| 37 | 75 | 120 | ∘ | 552 | ∘ |
| 38 | 75 | 115 | ∘ | 487 | ∘ |
| 39 | 75 | 98 | ∘ | 376 | ∘ |
| 40 | 75 | 10 | x | — | ∘ |
| 41 | 75 | 5 | x | — | ∘ |
| 42 | 75 | 3 | x | — | ∘ |

As shown in Table 1 above, in the case in which the particle diameter of the non-conductive particle is greater than 1000 nm, conductivity of the turn-on voltage controlling unit may decrease thereby rapidly increasing the turn-on voltage, a clamp voltage property may deteriorate, and printability may decrease due to coarse particles. In addition, in the case in which the particle diameter of the non-conductive particle is smaller than 120 nm, an interval between the conductive particles may not be secured thereby generating the leakage current, and the turn-on voltage may be difficult to control.

Further, in the case in which the non-conductive particles are contained in a content of less than 5 parts by weight based on 100 parts by weight of the conductive particles, the leakage current may occur, and in the case in which the non-conductive particles are contained in a content of more than 120 parts by weight based on 100 parts by weight of the conductive particles, the turn-on voltage properties may deteriorate, and printability and workability during the printing process may deteriorate due to an increase in viscosity of the static-protective composition.

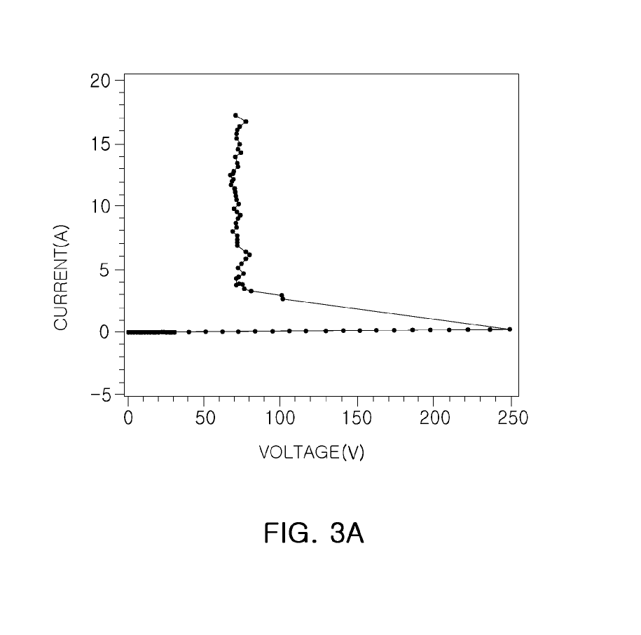

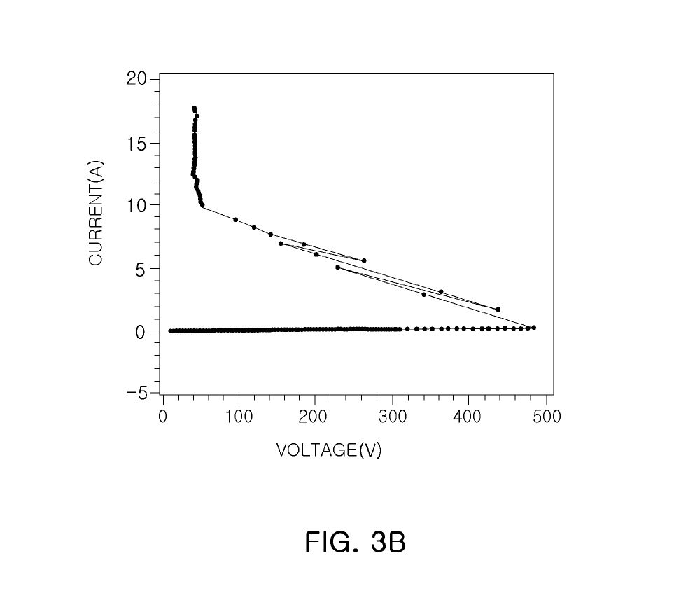

FIGS. 3A and 3B are graphs showing electrical properties of the static-protective component manufactured according to an exemplary embodiment of the present disclosure.

FIG. 3A is a graph showing an electrostatic discharge (ESD) suppression peak voltage (turn-on voltage) in the case of adding 10 parts by weight of the non-conductive particles, and FIG. 3B is a graph showing an electrostatic discharge (ESD) suppression peak voltage (turn-on voltage) in the case of adding 40 parts by weight of the non-conductive particles.

It may be seen from FIGS. 3A and 3B that in the case of adding the non-conductive particles having nano-sizes according to an exemplary embodiment of the present disclosure, the turn-on voltage may be easily controlled and the leakage current may not occur until the turn-on voltage is achieved.

As set forth above, according to exemplary embodiments of the present disclosure, a static-protective component and a static-protective composition capable of easily controlling a turn-on voltage and decreasing a leakage current may be provided.

While exemplary embodiments have been shown and described above, it will be apparent to those skilled in the art that modifications and variations could be made without departing from the spirit and scope of the present disclosure as defined by the appended claims.

What is claimed is:

1. A static-protective component comprising:
an insulating substrate;
first and second electrodes disposed on the insulating substrate, having a gap of a predetermined interval therebetween; and
a turn-on voltage controlling unit disposed at the gap and containing conductive particles and non-conductive particles each having a particle diameter of 120 nm to 1000 nm.

2. The static-protective component of claim 1, wherein the conductive particle has a particle diameter of 30 μm or less.

3. The static-protective component of claim 1, wherein the conductive particle has at least one of a spherical shape, a flake shape, and a plate shape.

4. The static-protective component of claim 1, wherein the non-conductive particles are contained in a content of 5 to 120 parts by weight based on 100 parts by weight of the conductive particle.

5. The static-protective component of claim 1, wherein the non-conductive particle contains at least one of a metal oxide and a semiconductor oxide.

6. The static-protective component of claim 1, wherein the turn-on voltage controlling unit further includes a binder resin.

7. The static-protective component of claim 6, wherein the binder resin is contained in a content of 5 to 40 parts by weight based on 100 parts by weight of a solid content containing the conductive particles and the non-conductive particles.

8. The static-protective component of claim 6, wherein the binder resin is a thermosetting resin.

9. A static-protective composition comprising:
conductive particles;
non-conductive particles each having a particle diameter of 120 nm to 1000 nm; and
a binder resin.

10. The static-protective composition of claim 9, wherein the non-conductive particles are contained in a content of 5 to 120 parts by weight based on 100 parts by weight of the conductive particle.

11. The static-protective composition of claim 9, wherein the binder resin is contained in a content of 5 to 40 parts by weight based on 100 parts by weight of a solid content containing the conductive particles and the non-conductive particles.
